(19) United States
(12) Patent Application Publication
(10) Pub. No.: US 2019/0162579 A1
(43) Pub. Date: May 30, 2019

(54) MODULAR WEIGHT SCALE SYSTEM

(71) Applicant: Agalmic Inc., San Francisco, CA (US)

(72) Inventors: David Wiens, San Francisco, CA (US); Jordan Hurwich, San Francisco, CA (US)

(73) Assignee: Agalmic Inc., San Francisco, CA (US)

(21) Appl. No.: 16/201,744

(22) Filed: Nov. 27, 2018

Related U.S. Application Data
(60) Provisional application No. 62/592,266, filed on Nov. 29, 2017.

(51) Int. Cl. G01G 3/147; G01G 21/22; G01G 19/393; G01G 3/13; G01G 3/14

(52) U.S. Cl. CPC G01G 3/147; G01G 21/22; G01G 3/1404; G01G 3/13; G01G 19/393

(57) ABSTRACT

A system includes modules forming an array. Each module is coupled to a neighboring module and includes flexures. Each flexure is configured to measure a load value of the module. A module board is connected to the flexures, configured to receive the load value and combine into a load module output. The load module output is within an initial module output range. A resistor is configured to set the initial module output range, which is the same for each module in the array. A microcontroller is configured to receive an input for the initial module output range, which is a difference between an output for a full-load state and a zero-load state, and configured to receive the load module output of each module, convert the load module output into a bit number, scale the bit number to generate an adjusted bit number. This represents a weight applied to the array.

### RELATED APPLICATIONS

This application claims priority to U.S. Provisional Patent Application No. 62/592,266 filed on Nov. 29, 2017 and entitled “Modular Weight Scale System,” which is hereby incorporated by reference in full.

### BACKGROUND

Portable, lightweight scales utilized for the purpose of weighing objects are well known in the art, and are available in a myriad of designs. Typically, portable, lightweight scales are a fixed size or designed for a specific case. It is difficult to weigh two different objects having a large differential between their sizes and weights, i.e., a bag of feathers versus five bowling balls, by using the same scale with the same degree of accuracy.

### SUMMARY

A system includes a plurality of modules forming an array. Each module of the plurality of modules is coupled to a neighboring module of the plurality of modules, and each module includes one or more flexures. Each flexure is configured to measure a load value of the module. A module board is connected to the one or more flexures. The module board is configured to receive the load value from each flexure and combine the load value from each flexure into a load module output. The load module output is within an initial module output range. A resistor is connected to the module board and configured to set the initial module output range of the module in the array. The initial module output range is the same for each module in the array. A microcontroller is configured to receive an input for the initial module output range. The initial module output range is a difference between an output for a full-load state and an output for a zero-load state. The microcontroller is configured to receive the load module output of each module, convert the load module output into a bit number and scale the bit number to generate an adjusted bit number. The adjusted bit number represents a weight of the load applied to the array. A radio is configured to transmit the adjusted bit number to a backend.

Some embodiments involve a method including providing a module of a plurality of modules forming an array. Each module of the plurality of modules is coupled to a neighboring module of the plurality of modules. The module includes one or more flexures, and each flexure is configured to measure a load value. A module board is connected to the one or more flexures and a resistor is connected to the module board. A microcontroller receives an input for an initial module output range being a difference between an output for a full-load state and an output for a zero-load state. The resistor sets the initial module output range for each module in the array. The initial module output range is the same for each module in the array. The module board receives the load value from each flexure and combines the load value from each flexure into a load module output. The load module output is within the initial module output range. The microcontroller receives the load module output of each module, converts the load module output into a bit number and scales the bit number into a scaled bit number to generate, from the scaled bit number, an adjusted bit number. The adjusted bit number represents a weight of the load applied to the array. A radio transmits the adjusted bit number to a backend.

Some embodiments involve a method including providing a module of a plurality of modules forming an array. Each module of the plurality of modules is coupled to a neighboring module of the plurality of modules. The module includes one or more flexures, and each flexure is configured to measure a load value. A module board is connected to the one or more flexures. The module board receives the load value from each flexure and combines the load value from each flexure into a load module output. The load module output is within the initial module output range. A microcontroller receives the load module output of each module, converts the load module output into a bit number and scales the bit number into a scaled bit number to generate, from the scaled bit number, an adjusted bit number. The adjusted bit number represents a weight of the load applied to the array. A radio transmits the adjusted bit number to a backend.

### BRIEF DESCRIPTION OF THE DRAWINGS

FIG. 1 is a simplified schematic of an example environment for the method or system, in accordance with some embodiments.

FIGS. 2A and 2B are top views of the top surface of an example module, in accordance with some embodiments.

FIG. 3 is a bottom view of the underside of an example module, in accordance with some embodiments.

FIGS. 4A and 4B are bottom views of the underside of an example array, in accordance with some embodiments.

FIG. 5 shows a close-up view of an example of multiple modules fastened together as shown in FIG. 4B, in accordance with some embodiments.

FIGS. 6A and 6B are an example flexure of an example scale system, in accordance with some embodiments.

FIGS. 7A, 7B and 7C are simplified schematics of an example wiring configuration of the flexures on a module, in accordance with some embodiments.

FIGS. 8A and 8B illustrate an example module board, in accordance with some embodiments.

FIG. 9 is simplified schematics comparing a central board wiring configuration versus a daisy chain wiring configuration, in accordance with some embodiments.

FIG. 10 is a simplified flowchart of an example method for trimming, in accordance with some embodiments.

FIG. 11 depicts a table of data for an example implementation of a method for trimming, in accordance with some embodiments.

FIG. 12 depicts a simplified schematic of an example wiring configuration of the flexures and the potentiometer, in accordance with some embodiments.

FIG. 13 is a bottom view of the underside of an example array, in accordance with some embodiments.

FIG. 14 is a simplified flowchart of an example process for mapping an array capacity to broadcast values, in accordance with some embodiments.

FIG. 15A is a simplified table of example output ranges for an example system, in accordance with some embodiments.

FIG. 15B is a simplified example of mapping an array in an example implementation for the system, in accordance with some embodiments.

FIG. 16 is a simplified flowchart of an example method for measuring weight, in accordance with some embodiments.

FIG. 17 is a top view of an example array of a scale system, in accordance with some embodiments.

### DETAILED DESCRIPTION

A system and method for measuring weight are described herein. The scale system is configurable depending on the shape and size of the object to be weighed. A plurality of scale modules, each having a different size or shape, but similar component configurations, can be electrically and physically connected together in arrays having a customized arrangement or configuration for weighing objects of different sizes or shapes. The same components can thus be reconfigurable for a different object that varies greatly in size and shape from another object, but weighed with the same degree of accuracy, provided the hardware is capable. This is achieved in some embodiments by using a method for trimming the modules included in the array of the scale system through a resistor such as a potentiometer, a laser trimmed resistor or another resistive element. This ensures that each module has the same output range regardless of the weight of the object or where the object is placed on scale system.

The sensitivity of the scale system may be chosen by a user depending on the relative weight of the object to be weighed. In this way, the weight of a very light object is measured with the same relative degree of accuracy as the weight of a very heavy object, provided the hardware is capable. This is achieved by combining the output of the modules in the array while a load is applied and converting the output to a bit number. The bit number is scaled, and an adjusted bit number is generated which represents a weight of the load applied to the array. The adjusted bit number is transmitted by, for example, a radio, to a backend, and the backend converts the adjusted bit number to an actual weight measured by the system.

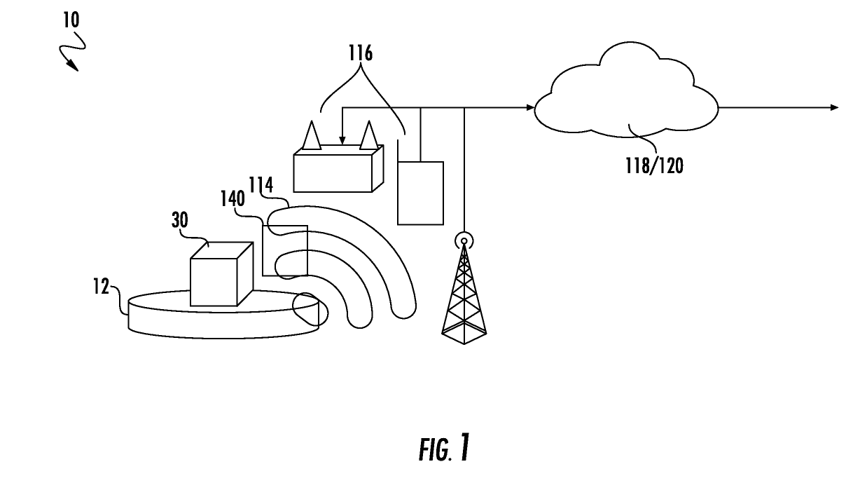

In order to measure the weight of a variety of objects with the same scale system, a modular scale system 10 is designed. FIG. 1 is a simplified schematic of an example environment for the method or system, in accordance with some embodiments. An array 12 is a scale that is configured to generate data 140, such as a measurement, when a load 30 is applied to the array. The data 140 is indicative of the weight of the load 30. The data 140 is transmitted through a communication technology 114, such as a WiFi system, Bluetooth® wireless technology, Bluetooth® Low Energy, cellular communications, satellite communications or the like, as well as combinations thereof. A device 116 (such as a router, smartphone, hub, cellular network transceiver or the like or combinations thereof) receives the data 140 and relays it to a backend 120. The backend 120 is configured through a server 118 and may include the server 118 or a computer with access to an internal database and an external database. In other embodiments, the backend 120 may be cloud-based, a standalone server, a server farm, or one or more separate computing devices. The backend 120 converts the data 140 to weight information, and records, stores or transmits the information. U.S. patent application Ser. No. 15/490,681, filed Apr. 18, 2017, entitled “Platform for Prediction of Consumption and Re-Ordering of Goods” is incorporated by reference as if fully set forth herein, and includes (among other disclosures) a system for using such weight information. In some embodiments, the array 12 may be used as the tracking unit as described in U.S. patent application Ser. No. 15/490,681.

In some embodiments, the scale system 10 is supported by software which enables the scale system 10 to be set to particular parameters, operate in the manner described herein, and communicate within the scale system 10 and outside of the scale system 10. For example, a user or system administrator may use the software to configure the scale system 10.

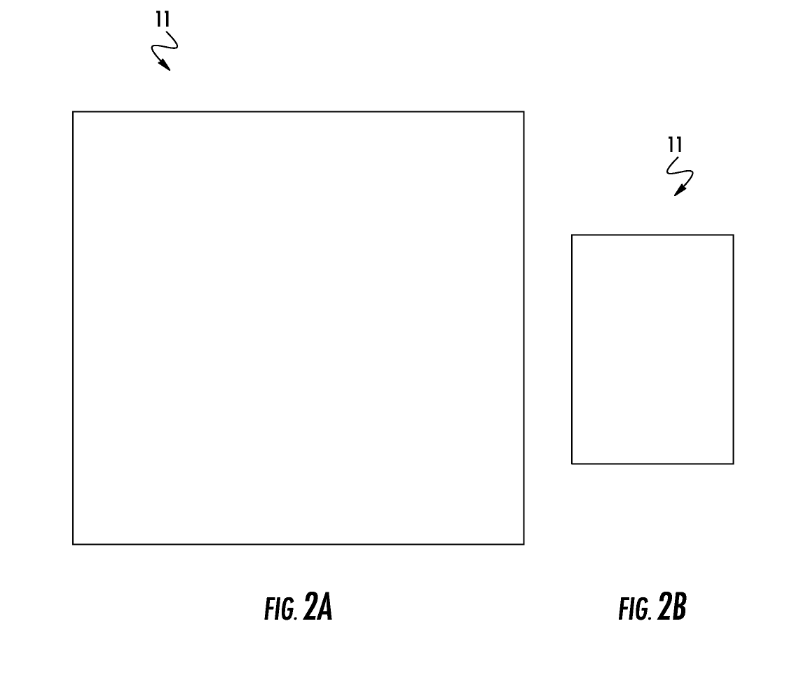

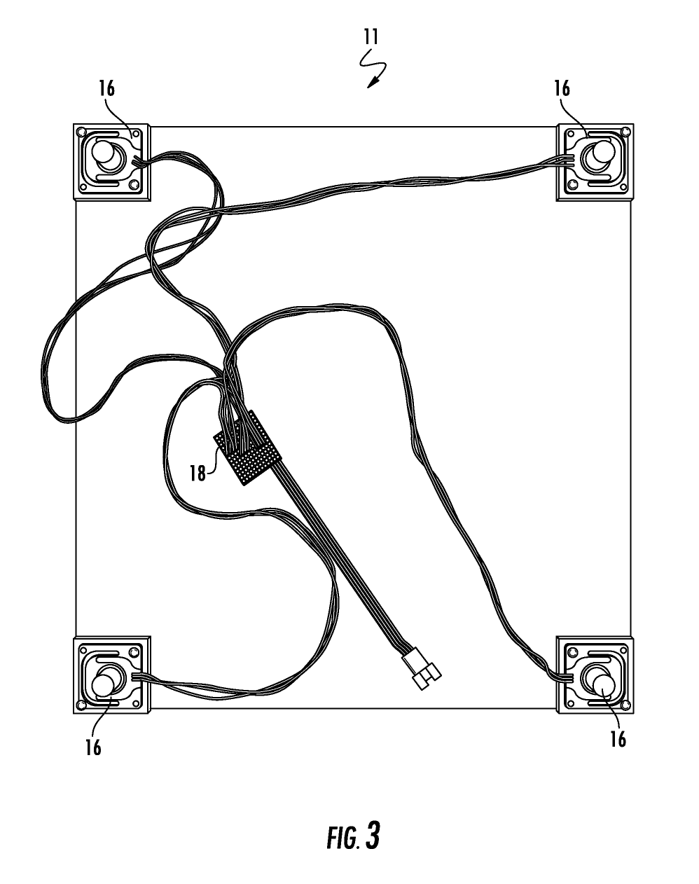

FIGS. 2A and 2B are top views of the top surface of different example modules 11, in accordance with some embodiments. One or more modules 11 may be connected together to form the array 12 of different shapes and sizes as necessary. For example, a module 11 is coupled mechanically to a neighboring module 11 forming an array 12 of a variety of sizes and shapes. In non-limiting examples, FIG. 2A shows the shape and size of the module 11 as, for example, a square 12 inches by 12 inches (e.g., 12×12), and in FIG. 2B, the shape and size of the module 11 as, for example, a rectangle 4 inches by 6 inches (e.g., 4×6). The shapes and sizes of the module 11 are for example only and other shapes such as diamonds, trapezoids, pentagons, circles, ovals or the like may be used, as well as various sizes. The different sized modules 11 can be used to achieve many different physical shapes, sizes and capacities for the array 12, which is configurable and reconfigurable to meet a wide range of use case requirements while enabling lower manufacturing and inventory holding costs.

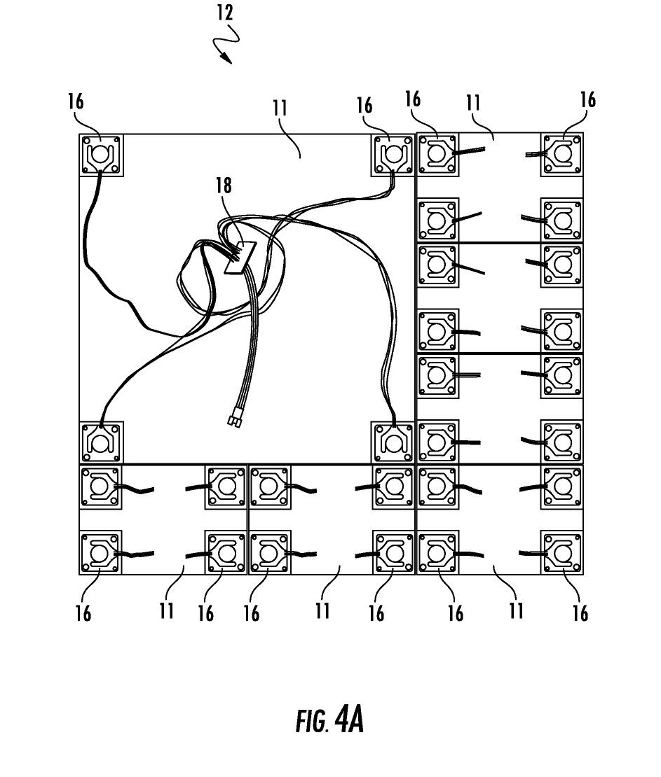

FIG. 3 is a bottom view of the underside of an example module 11, in accordance with some embodiments. On each module 11, one or more flexures 16 may be coupled in a suitable location, such as the corners. In this example, the flexures 16 are coupled to the module 11 in the corners such that the module 11 has four flexures 16. The number of flexures 16 per module 11 may vary based on the size and shape of the module 11. In some embodiments, there may be a close-out panel that slides or snaps on the underside of each module 11 to cover and protect the flexures 16 as well as other components coupled to the module 11.

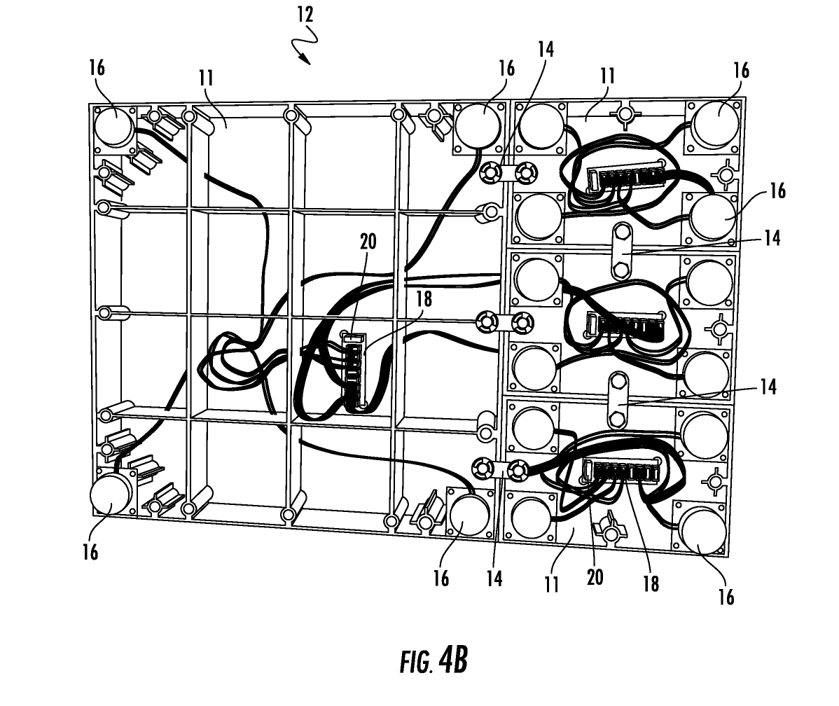

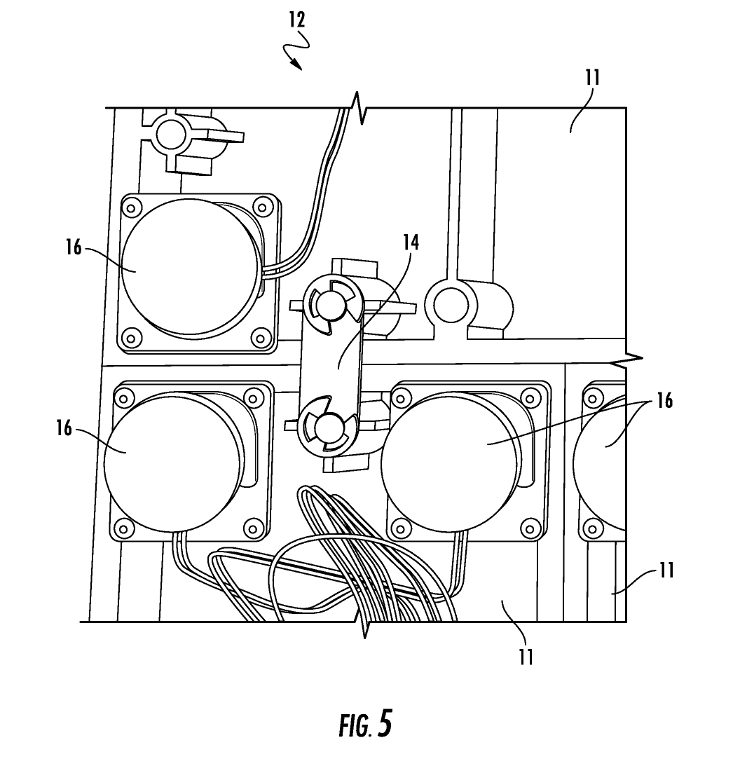

FIGS. 4A and 4B are bottom views of the underside of example arrays 12 of different configurations, in accordance with some embodiments. Modules 11 may be coupled mechanically to a neighboring module forming an array 12. In non-limiting examples, FIG. 4A is the array 12 made up of one (12×12) module 11 and six (4×6) modules 11, thereby creating a 16 inches by 16 inches (e.g., 16×16) array 12. FIG. 4B is the array 12 comprised of one (12×12) module 11 and three (4×6) modules 11, thereby creating a 12 inches by 16 inches (e.g., 12×16) array 12. The modules 11 are coupled mechanically to a neighboring module 11 forming the array 12 by a mechanical fastener 14. FIG. 5 shows a close-up view of an example of multiple modules fastened together as shown in FIG. 4B, in accordance with some embodiments. The mechanical fastener 14 may be bolts, screws, brackets, magnets, hook and loop, hooks, two-sided tape, glue or the like. If not permanently connected together, then the modules 11 can be added or subtracted from the array 12 to meet changing use case requirements on the fly. The mechanical fastener 14 connecting the modules 11 may be located on the underside of the modules 11, the topside of the modules 11, or between the modules 11.

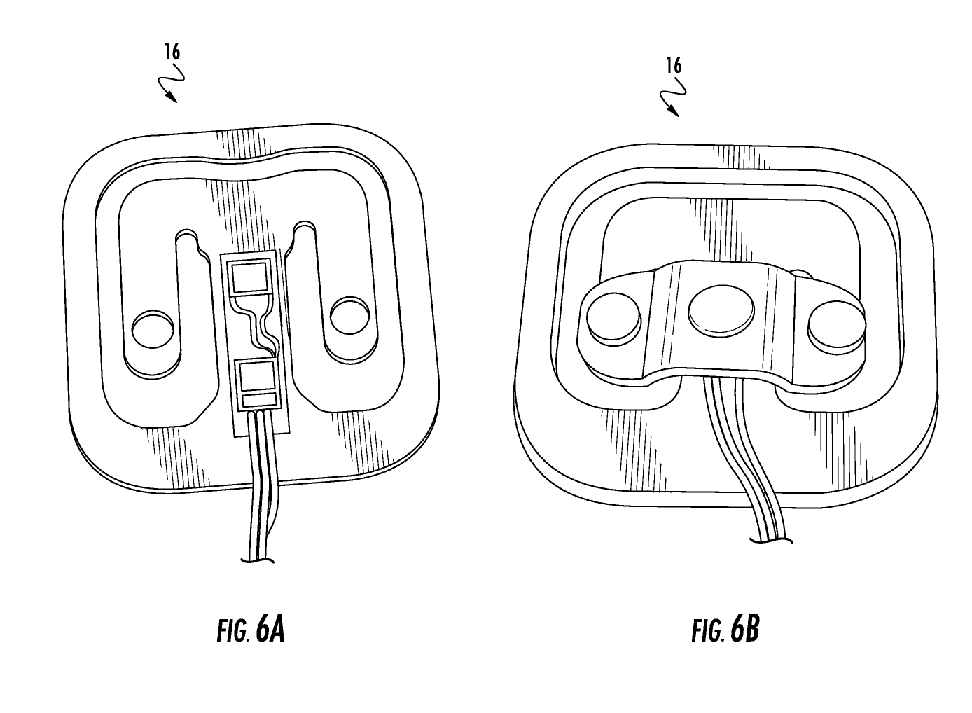

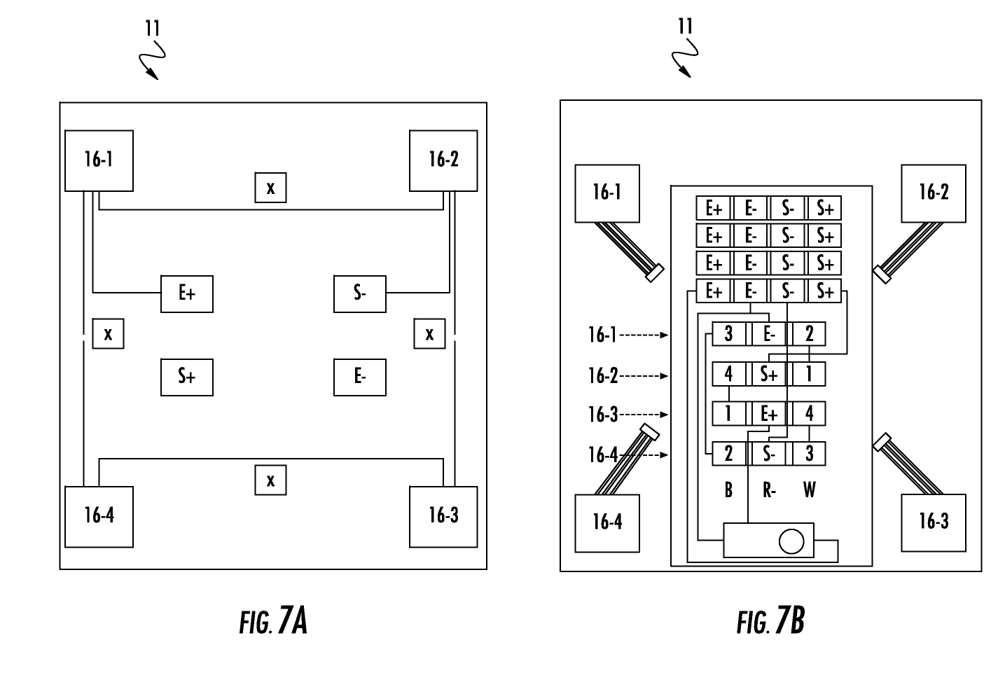

FIGS. 6A and 6B are an example flexure 16 of an example scale system 10, in accordance with some embodiments. The flexure 16 is a measurement device, such as a strain gauge, pressure gauge, piezoelectric device, piezo-resistive device or the like. The flexure 16 is shown as a strain gauge in FIGS. 6A and 6B. When a load is applied to the module 11 so the weight can be measured, for example, the resistance of a strain gauge is proportional to the load applied to that strain gauge. As the load increases, the resistance changes due to the expansion (e.g., tension) or contraction (e.g., compression) of the strain gauge. The strain gauge may be ¼ bridge, ½ bridge (biaxial), or a full bridge having three or more wires (i.e., E+, E−, S+ and or S−) and wired together for example, in a wheatstone bridge configuration (as described below) with the other strain gauges that comprise the flexures 16 of the module 11.

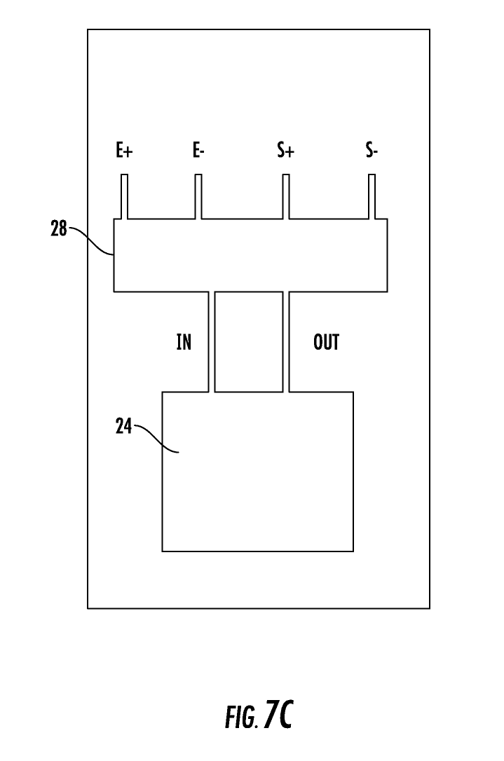

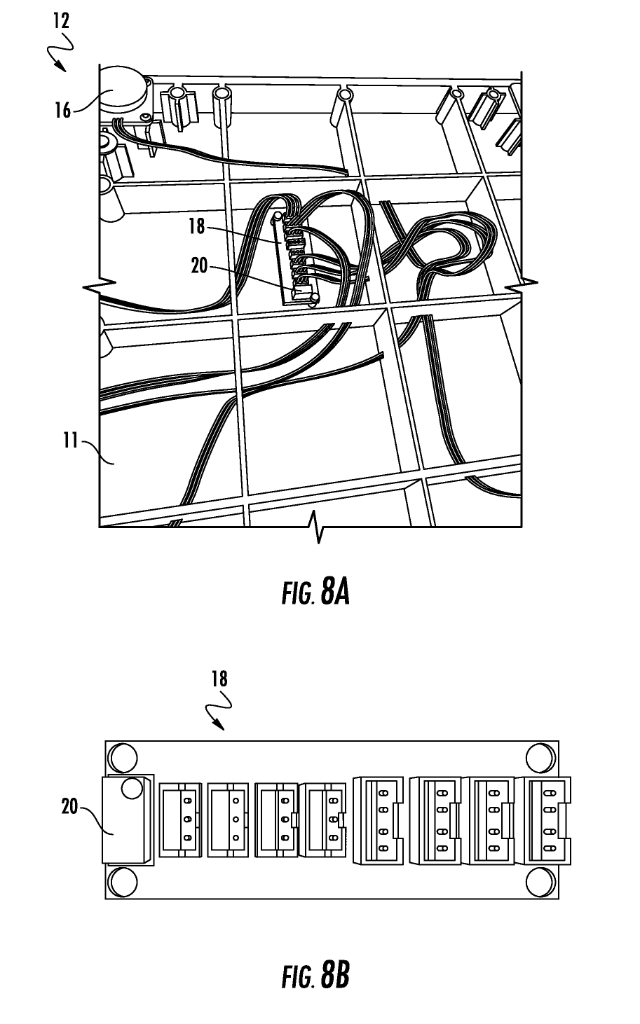

FIGS. 7A, 7B and 7C are simplified schematics of an example wiring configuration of the flexures 16 on a module 11, in accordance with some embodiments. Wires E+ and E− provide a current through the wheatstone bridge circuit. When a load is applied, the resistance of the strain gauges (i.e., flexures 16) change proportionally to the load. S+ and S− provide a voltage differential which is proportional to the load. This voltage differential may be read by an Analog to Digital Converter (ADC) 28 and transmitted by a radio 24.

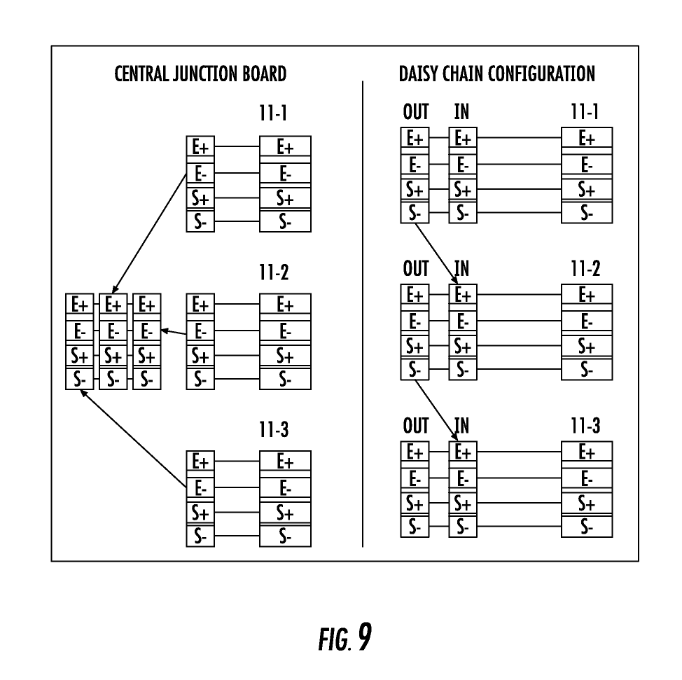

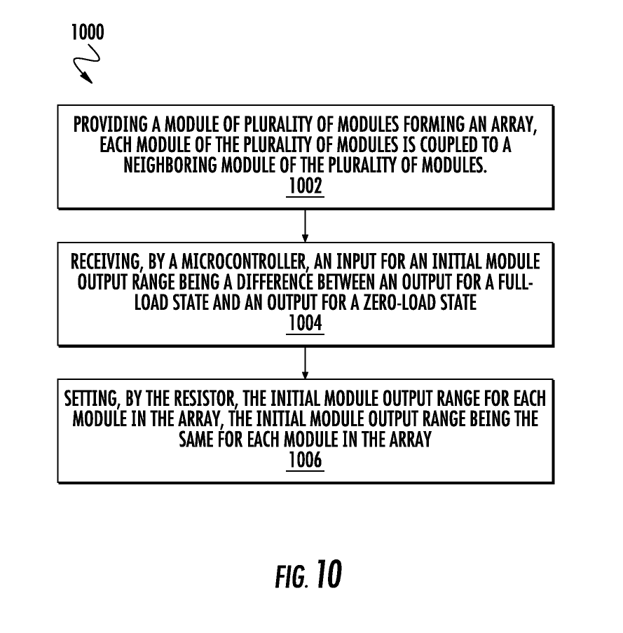

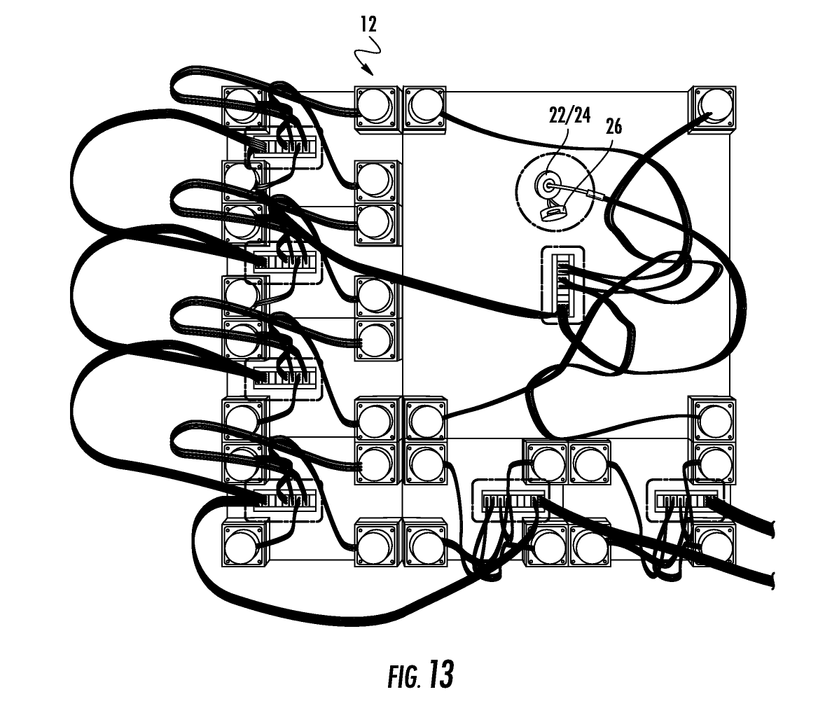

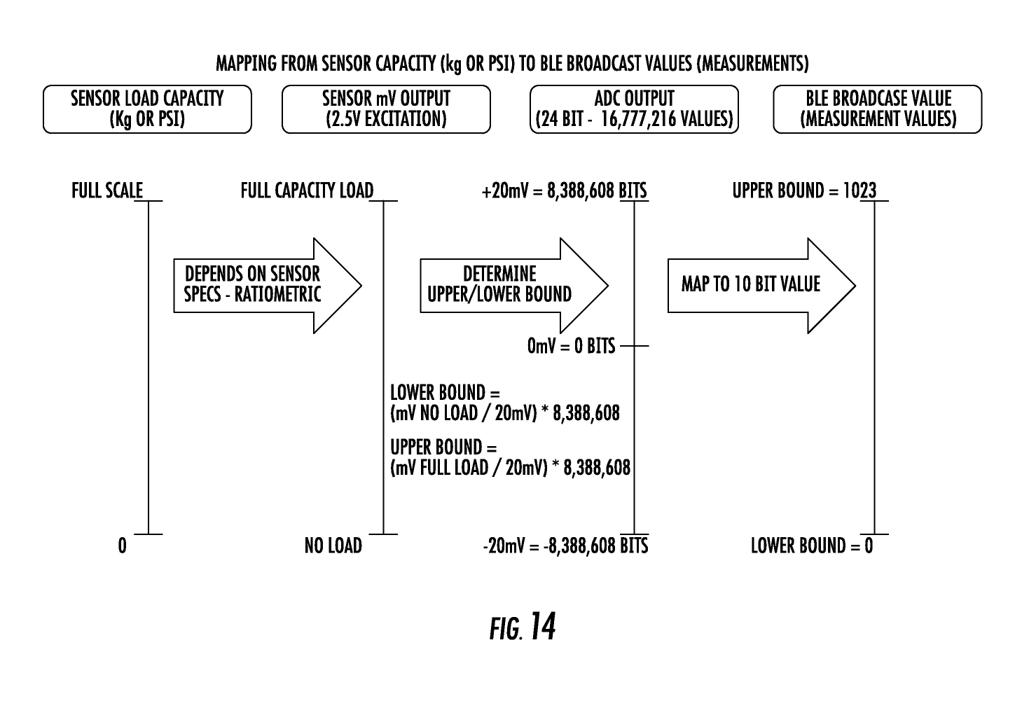

FIGS. 8A and 8B illustrate an example module board 18, in accordance with some embodiments. The wires of the flexures 16 of each module 11 are routed and connected to a module board 18 so that each module 11 in the array 12 has one module board 18. Module 11 is coupled electrically in parallel to a neighboring module 11 in the array 12 via their module boards 18. FIG. 9 is simplified schematics comparing a central board wiring configuration of the module versus a daisy chain wiring configuration, in accordance with some embodiments. In one embodiment, each module 11 is electrically connected to the neighboring module in the array 12 of the scale system 10 in a parallel wiring circuit in a daisy chain configuration, as shown in FIG. 9 (as well as in FIGS. 4A, 4B and 13). For clarity, the example modules 11 in the array 12 are labeled as 11-1, 11-2 and 11-3. Among other benefits, this simplifies the wire routing and assembly method by minimizing the amount of wire used when compared to the conventional method of using a central board wiring configuration.

In some embodiments, once the modules 11 are connected to form the array 12, the scale system 10 may communicate the configuration to the backend 120. For example, an App on a device, such as a mobile device, may scan an identifier such as a barcode, RFID tag, QR code, or the like, associated with each module 11. Data collected from each module 11 is sent to the backend 120 and the backend 120 recognizes the identifier and may track and monitor the data collected from each module 11. In this way, the backend 120 is aware of the configuration of the array 12 of the scale system 10. In some embodiments, the wiring from one module 11 may be routed to the neighboring module 11 via the module board 18.

Flexures 16 are typically manufactured in bulk and inexpensively. Due to the difference in brands and manufacturing, very few flexures 16 behave identically because each flexure 16 has an inherent resistance behavior which may vary from another flexure 16. For example, at a zero-load state, the flexure 16 may vary by +/−0.3 mV/V, whereas at a full-load state, the flexure 16 may vary by +/−0.20 mV/V based on their printed or known specifications. Therefore, at a zero-load state, the flexure output can vary +/−50% of full-load state.

Each flexure 16 is configured to generate a value when a load is applied to the module 11 or the array 12. The module board 18 is connected to the one or more flexures 16 of one or more modules 11 and combines the values therefrom into a load module output, e.g., as generated by the wheatstone bridge circuit configuration. The load module output is within an initial module output range. The initial module output range is a difference between an output for a full-load state and an output for a zero-load state. In other words:

Initial module output range=(output for a full-load state)−(output for a zero-load state)

In one embodiment, a resistor 19, such as a potentiometer 20, a laser trimmed resistor or another resistive element, on each module board 18 is configured to set the initial module output range to the same initial module output range for each module 11 in the array 12. This is part of a method for trimming 1000 and ensures that each individual module 11 has the same initial module output range, thus providing integrity in the array 12 and achieving a high degree of accuracy when measuring the weight. This allows the load to be placed anywhere on the array 12 and the same value will be generated. In one embodiment, the method for trimming 1000 is performed during manufacturing. In other embodiments, trim pots or laser-trimmed resistors may be used instead of the potentiometer 20 for the method for trimming 1000.

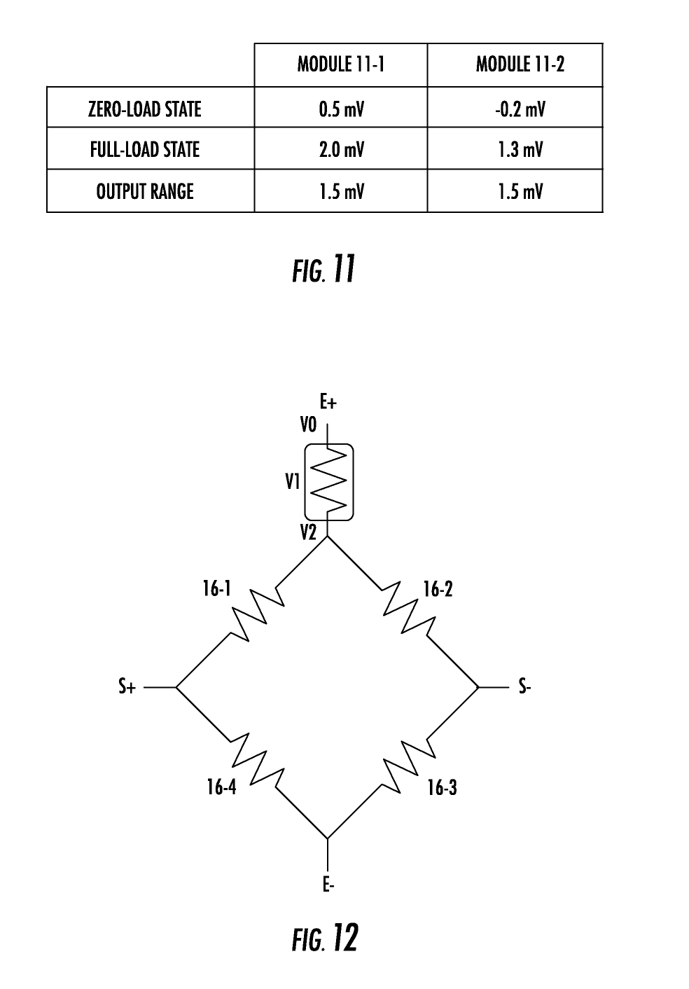

FIG. 10 is a simplified flowchart of an example method for trimming 1000, in accordance with some embodiments. The method for trimming 1000 starts at step 1002 by providing a module 11 of a plurality of modules forming an array 12. Each module 11 of the plurality of modules is coupled to a neighboring module 11 of the plurality of modules. The module 11 includes one or more flexures 16, and each flexure 16 is configured to measure a load value when a load is applied to the module 11. A module board 18 is connected to the one or more flexures 16, and a resistor 19 is connected to the module board 18. At step 1004, a microcontroller 22 receives an input for an initial module output range which is a difference between an output for a full-load state and an output for a zero-load state. In some embodiments, the input for the initial module output range is received from a user, pretest based on the flexure 16 specifications, or defined by the user at the time of sale and prior to manufacturing. At step 1006, a resistor 19, such as the potentiometer 20, sets the initial module output range for each module 11 in the array 12. The initial module output range is the same for each module 11 in the array 12.

FIG. 11 depicts a table of data for an example implementation of a method for trimming, in accordance with some embodiments. For example, module 11-1 and module 11-2 have different initial module outputs from one another when recorded at zero-load state and at full-load state. These differences may be due to the variation in the flexures 16 (e.g., different brands, manufacturing process or the like). When the method for trimming 1000 is performed with the potentiometer 20 on the module board 18, each initial module output is set to the same value. In this example, the initial module output for module 11-1 and module 11-2 are set to 1.5 mV.

FIG. 12 depicts a simplified schematic of an example wiring configuration of the flexures 16 and the potentiometer 20, in accordance with some embodiments. As shown, V1 is the voltage drop across the potentiometer 20 (or variable resistor) such that V2=V0−V1. V2 is the excitation voltage for the wheatstone bridge circuit. By adding the potentiometer 20, the initial module output range of each module 11 can be adjusted or set to a desired initial module output range. In one embodiment, the output of the flexure 16 at the low end of the manufacturer specifications is chosen and the potentiometer 20 is used to set the initial module output range of the module 11. This is repeated for all of the modules 11 in the array 12 so that all of the modules 11 in the array 12 have the same initial module output range. This ensures each module 11 in the array 12 will yield the same measurement value when a load is applied anywhere on the array 12. This phenomenon is how a single array 12 behavior is achieved when using multiple modules 11. In one embodiment, after the trimming process 1000 is performed, the inherent difference in the initial module output for each of the modules 11 is less than 0.1% and thus negligible.

FIG. 13 is a bottom view of the underside of an example array 12, in accordance with some embodiments. The modules 11 in the array 12 are coupled electrically in parallel to a neighboring module 11. Therefore, in the scale system 10, a microcontroller 22, a radio 24 and a battery 26 are used and may be wired to, or included with, any one of the module boards 18 of the module 11 in the array 12. In some embodiments, only one microcontroller 22, one radio 24 and one battery 26 are needed for the entire scale system 10 and can be connected to any of the module boards 18 in the scale system 10. In some embodiments, the microcontroller 22, radio 24 and battery 26 may be routed to one of the module boards 18, but be located in a convenient location outside of the array 12.

The microcontroller 22 and radio 24 may be part of a printed circuit board (PCB). Once the module 11 is coupled to at least one neighboring module 11 and the array 12 is formed, a load may be applied to the array 12 to measure the weight of the load. The load may be typical household products such as food, cosmetics, paper products, pet items or the like. These may be consumable goods such as oatmeal, milk, toothpaste, soap, toilet paper, diapers, or cat food. The module board 18 receives the load value from each flexure 16 and combines the load value from each flexure 16 into the load module output. The load module output is within the initial module output range. In some embodiments, the microcontroller 22 receives the load module output from each module 11 in the array 12 and converts the load module outputs into a bit number. In some embodiments, the microcontroller 22 receives the load module outputs from the modules 11 in the array 12 as a combined load output value of the array 12 and converts the combined load output value into the bit number. The microcontroller scales the bit number and generates an adjusted bit number. The adjusted bit number represents a weight of the load applied to the array 12.

In some embodiments, the microcontroller 22 has an Analog to Digital Converter (ADC) 28 electrically connected to receive the load module outputs and generate the bit number. The ADC 28, as shown in FIG. 7C, converts an analog voltage on a pin to a digital number. One type of ADC uses the analog voltage to charge up an internal capacitor and then measures the time it takes to discharge across an internal resistor. A microcontroller may monitor the number of clock cycles that pass before the capacitor is discharged. This number of cycles is the number that is returned once the ADC is complete.

In one embodiment, the ADC 28 is a 24-bit ADC, meaning it has the ability to detect 16,777,216 (2²⁴) discrete analog levels. Moreover, an input voltage range (S+/S− voltage) is −9.76562 mV to 9.76562 mV, or 19.53 mV total, and converts that range to 2²⁴ or 16,777,216 possible discrete levels. The 24-bit number is scaled to an adjusted 10-bit number (2¹⁰ or 1024 possible discrete levels). To maximize the use of the 1024 possible discrete levels, the portion of the 24-bit range that is associated with the output is specified. The lower bit number, or step 0, is defined as the ADC reading at zero-load state. The upper bit number, or step 1023, is defined as the ADC reading at full-load state.

The ADC reading may be related to voltage by:

$$\frac{System Output ( mV )}{Input Voltage Range ( mV )} = \frac{ADC Output}{Resolution of ADC}$$

In a first non-limiting example, the array 12 is set to a full-load state of 100 kg at 1.5 mV and the input voltage range is 19.53 mV (+/−9.765 mV). This means that when 100 kg is placed on the array 12, the full-load state reading is 1.5 mV. Because the ADC 28 has a 24-bit range, a 1.5 mV reading equals 1,288,573 possible discrete levels (no scaling).

Therefore:

$$\frac{1.5 mV}{19.53 mV} = \frac{ADC Ouput}{16 \text{,} 777 \text{,} 216} = > 1 \text{,} 288 \text{,} 573 possible discrete levels$$

In a second non-limiting example, the 24-bit number of 1,288,573 possible discrete levels is scaled to a 10-bit adjusted number. The full-load state reading of the module 11 of 1.5 mV can be scaled from a 24-bit number to a 10-bit adjusted number by scaling the input voltage range. For example, the 24-bit number of 1,288,573 represents the maximum input voltage expected of 1.5 mV. Therefore, the input voltage range can be scaled in firmware from 19.53 mV to 1.5 mV such that 0 mV and 1.5 mV are mapped to 10-bit numbers 0 and 1023 respectively; 1024 possible discrete levels. In this second example, fidelity is lost when the 24-bit number is scaled to a 10-bit number, but optimized over 10-bits by scaling the input voltage to the system expected voltage of 0-1.5 mV.

Returning to the second example, when scaled, 1.5 mV, which represents the max input voltage of the system, is not 1,288,573 possible discrete levels, but the 10-bit equivalent of 1023. Therefore, scaling the input voltage range to 1.5 mV:

$$\frac{1.5 mV}{1.5 mV} = \frac{10 \text{-} bit adjusted}{{2}^{10}} = > 1023$$

The adjusted bit number of 1023 represents the weight of the 100 kg load applied to the array 12.

In a third non-limiting example, a 24-bit number is scaled to a 10-bit adjusted number. The input voltage range is set to the full-load state reading of 1.5 mV. If a 50 kg load is placed on the array 12:

$$\frac{1.5 mV}{1.5 mV} = \frac{{2}^{10}}{1 \text{,} 288 \text{,} 573} = > \frac{{2}^{10}}{1 \text{,} 288 \text{,} 573} = \frac{adjusted 10 \text{-} bit}{\frac{( 50 kg ) \times 1 \text{,} 288 \text{,} 573}{( 100 kg )}} = > 512$$

Whereas when a 10-bit number is not scaled and the 50 kg is placed on the array 12:

$$\frac{19.53 mV}{19.53 mV} = \frac{{2}^{10}}{16 \text{,} 777 \text{,} 216} = > \frac{{2}^{10}}{16 \text{,} 777 \text{,} 216} = \frac{10 \text{-} bit}{\frac{( 50 kg ) \times 1 \text{,} 288 \text{,} 573}{( 100 kg )}} = > 39$$

The adjusted bit number represents a weight of the load applied to the array 12 and is transmitted to the backend 120. The backend 120 receives the adjusted bit number, which is between 0-1023 (i.e., 1024 values). Since the user configured the scale system 10, and in some embodiments, scanned the modules 11 in the array 12 to provide this information to the backend 120, the backend 120 is aware of the settings and can convert the adjusted bit number into the actual weight. For example, during the configuration of the scale system 10, the user scanned ten modules 11 to form the array 12, each having a capacity of 5 kg, so a total capacity of 50 kg. When an object is placed on the scale system 10, the adjusted bit number broadcasted is 1023, and the backend converts this to 50 kg. Likewise, if the adjusted bit number broadcasted is 512, the backend converts this to 25 kg. In some embodiments, the actual weight is transmitted to the device of the user through the scale system 10.

In some embodiments, software focuses on the specific ADC range and performs the scaling function to the 10-bit adjusted number. The modules 11 are modular and can be configured and reconfigured into different shapes and sizes to form the array 12 depending on what is to be weighed. This makes the scale system 10 customizable. After the array 12 is configured, the focused ADC range, or sensitivity, may be configurable via a mechanism such as a button, switch, knob, dial, lever or the like, coupled to the array 12. In some embodiments, this may be located with the microcontroller 22 for easy access by the user. The sensitivity is a scale based on a percentage of the full-load state.

In this way, the desired sensitivity and weight capacity for the scale system 10 are selected depending on the particular object to be measured. In some embodiments, the sensitivity may be set to 10% of full-load state, 25% of full-load state, 50% of full-load state, 75% of full-load state or 100% of full-load state. In other embodiments, the sensitivity may be set to ranges such as “0-50 grams”, “0-100 grams”, “0-200 grams”, “0-600 grams”, “0-1 kg”, “0-3 kg”, “0-5 kg”, “0-10 kg”, “0-20 kg”, “0-50 kg”, “0-75 kg” or “0-100 kg”. For example, the user may configure the scale system 10 to measure the weight of a carton of eggs by setting the sensitivity to 10% of full-load state or “0-50 grams,” whereas the user using the scale system 10 to measure the weight of a bag of pet food may set the sensitivity to 50% of full-load state or “0-20 kg”.

In a non-limiting example, the array 12 may have a full-load state reading set to 5000 g so that 1250 g load is 25%, a 2500 g load is 50% and a 5000 g load is 100%. The resulting 1024 possible discrete levels for a 10-bit adjusted number are spread over, for example, 1250 g, 2500 g and 5000 g depending on the sensitivity. This feature provides the user with options to achieve the best fidelity for the application. For example, a user can use the scale system 10 to measure the weight of a relatively ‘light’ object, such as a tube of toothpaste by coupling one or more modules 11 together, forming the array 12, selecting the sensitivity, such as 2% of full-load state, then placing the tube of toothpaste on the array 12. Then, the same scale system 10 may be used to measure the weight of a relatively ‘heavy’ object, such as a sack of potatoes by using the same modules 11 as described in the tube of toothpaste example, but this time, adding additional modules 11 to the array 12 to account for a larger surface area for the sack of potatoes, if necessary. The sensitivity may be selected to 100% of full-load state then the sack of potatoes may be placed on the array 12 to measure the weight.

In some embodiments, the radio 24 transmits the adjusted bit number to the backend 120. Scaling the 24-bit number to the 10-bit adjusted number allows the focus to be on the ADC range that applies to the array 12 while being mindful of the desired sensitivity of the scale system 10 based on what is being weighed. FIG. 14 is a simplified flowchart of an example process for mapping an array capacity to broadcast values, in accordance with some embodiments.

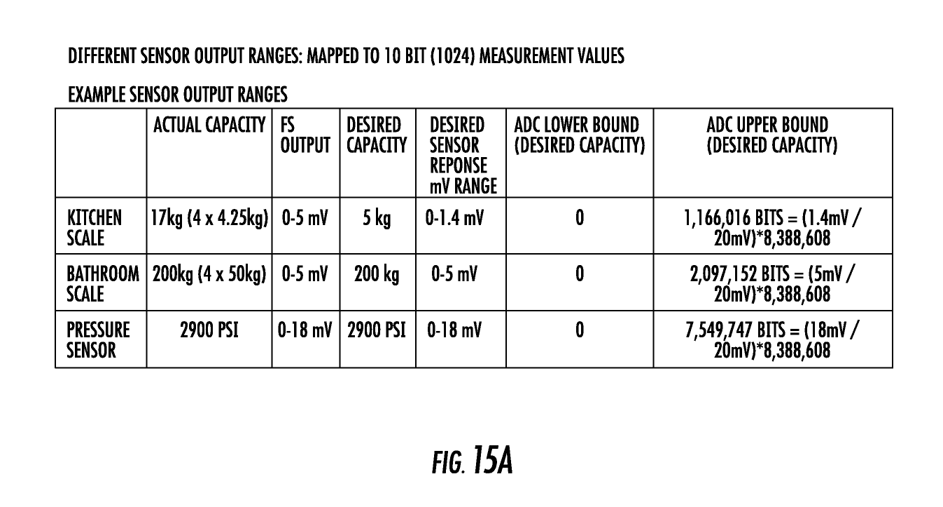

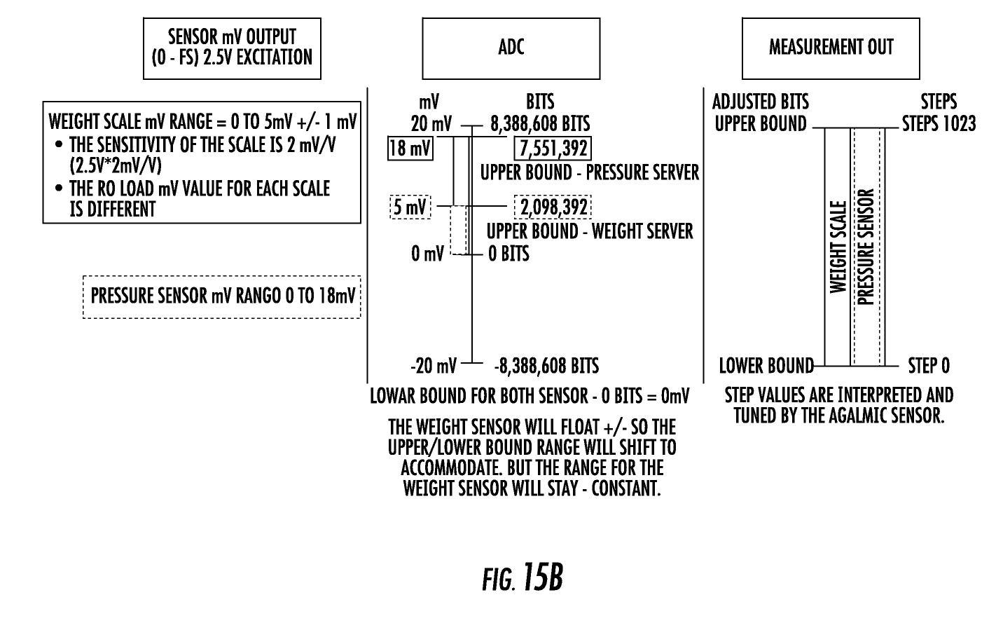

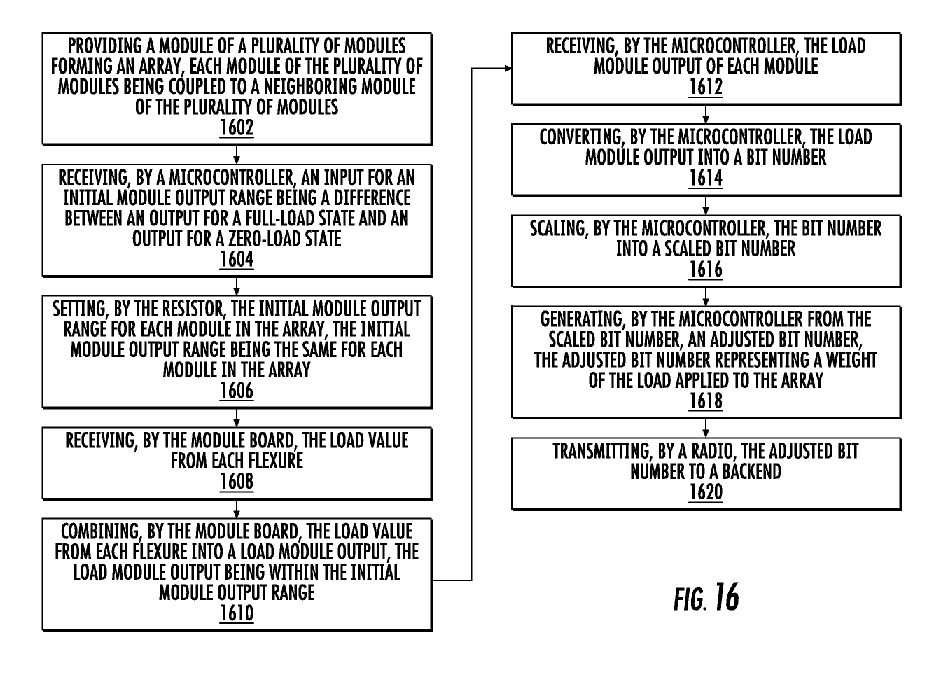

FIG. 15A is a simplified table of example output ranges for an example system, in accordance with some embodiments. FIG. 15B is a simplified example of mapping an array 12 in an example implementation for the system, in accordance with some embodiments. This demonstrates that by scaling as described, the same components of the modular scale system 10 can be used to measure the weight of objects having the desired capacity of 100 g as well as objects having the desired capacity of 5000 g with the same degree of accuracy by merely reconfiguring the modules 11 and setting the desired sensitivity based on the what is being weighed. Additionally, this may depend on the capabilities of the hardware.

In some embodiments, the system has a self-diagnostic check that may be activated by a second mechanism coupled to the scale system 10. This check may have different modes that determine if the scale system 10 is configured and connected correctly, if there is any damage to the components in the scale system 10, or if the scale system 10 is functioning improperly.

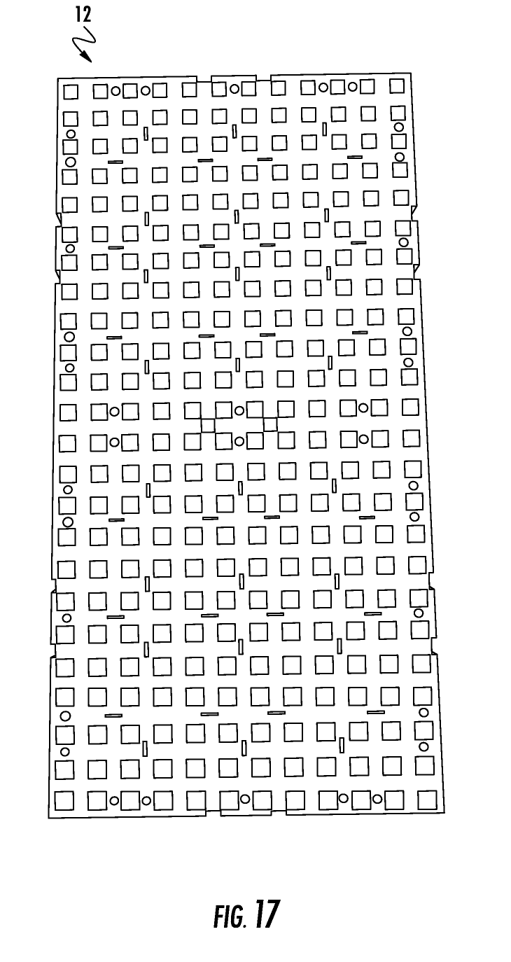

FIG. 16 is a simplified flowchart of an example method for measuring weight 1600, in accordance with some embodiments. In some embodiments, the method for measuring weight 1600 may start at step 1602 with the method for trimming 1000 as described in FIG. 10. In this method for measuring weight 1600, steps 1602-1606 are the same as steps 1002-1006. In some embodiments, the method may start at step 1608. For example, at step 1608, the module board 18 receives the load value from each flexure 16 and at step 1610, combines the load value from each flexure 16 into a load module output, e.g., as generated by the wheatstone bridge circuit. The load module output is within the initial module output range. At step 1612, a microcontroller receives the load module output from each module 11 in the array 12, e.g., resulting from the parallel connection configuration of the modules 11 in the array 12, and at step 1614, converts the load module output into a bit number. At step 1616, the microcontroller 22 scales the bit number into a scaled bit number, and at step 1618, the microcontroller 22 generates an adjusted bit number. The adjusted bit number represents a weight of the load 30 applied to the array 12. At step 1620, a radio 24 transmits the adjusted bit number to a backend 120. The backend 120 may convert the adjusted bit number to an actual weight measured by the system. The backend 120 may transmit the actual weight measured by the system to the scale system 10 or to the device of the user.

FIG. 17 is a top view of an example array 12 of a scale system 10, in accordance with some embodiments. This is one example form factor of the scale system 10. The user places an item to be measured on the top surface.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

What is claimed is:

1. A system comprising:
a plurality of modules forming an array, each module of the plurality of modules coupled to a neighboring module of the plurality of modules, each module comprising:
one or more flexures, each flexure configured to measure a load value of the module;
a module board connected to the one or more flexures, the module board configured to receive the load value from each flexure and combine the load value from each flexure into a load module output, the load module output being within an initial module output range; and
a resistor connected to the module board and configured to set the initial module output range of the module in the array, the initial module output range being the same for each module in the array;
a microcontroller configured to:
i) receive an input for the initial module output range, the initial module output range being a difference between an output for a full-load state and an output for a zero-load state; and
ii) receive the load module output of each module, convert the load module output into a bit number and scale the bit number to generate an adjusted bit number, the adjusted bit number representing a weight of the load applied to the array; and
a radio configured to transmit the adjusted bit number to a backend.

2. The system of claim 1, wherein the input for the initial module output range is received from a user.

3. The system of claim 1, wherein the microcontroller receives the load module output as a combined load module output of the array and converts the combined load module output into the bit number.

4. The system of claim 1, further comprising an analog to digital converter connected to the microcontroller and configured to receive the load module output and generate the bit number.

5. The system of claim 1, wherein the flexure is a strain gauge, pressure gauge, piezoelectric device, or piezo-resistive device.

6. The system of claim 1, wherein the resistor is a potentiometer or a laser trimmed resistor.

7. The system of claim 1, wherein each module is coupled to the neighboring module forming the array by a bolt, screw, bracket, magnet, hook and loop, hook, two-sided tape, or glue.

8. The system of claim 1, wherein each module is electrically connected to the neighboring module in the array in a parallel wiring circuit in a daisy chain configuration.

9. The system of claim 1, further comprising:
a mechanism coupled to the system and configured to set a sensitivity of the array, the sensitivity being a scale based on a percentage of the full-load state.

10. A method comprising:
providing a module of a plurality of modules forming an array, each module of the plurality of modules being coupled to a neighboring module of the plurality of modules, the module comprising:
one or more flexures, each flexure configured to measure a load value;
a module board connected to the one or more flexures; and
a resistor connected to the module board;
receiving, by a microcontroller, an input for an initial module output range being a difference between an output for a full-load state and an output for a zero-load state;
setting, by the resistor, the initial module output range for each module in the array, the initial module output range being the same for each module in the array;
receiving, by the module board, the load value from each flexure;
combining, by the module board, the load value from each flexure into a load module output, the load module output being within the initial module output range;
receiving, by the microcontroller, the load module output of each module;
converting, by the microcontroller, the load module output into a bit number;
scaling, by the microcontroller, the bit number into a scaled bit number;
generating, by the microcontroller from the scaled bit number, an adjusted bit number, the adjusted bit number representing a weight of the load applied to the array; and
transmitting, by a radio, the adjusted bit number to a backend.

11. The method of claim 10, wherein the flexure is a strain gauge, pressure gauge, piezoelectric device, or piezo-resistive device.

12. The method of claim 10, wherein the resistor is a potentiometer or a laser trimmed resistor.

13. The method of claim 10, wherein the module is electrically connected to the neighboring module in the array in a parallel wiring circuit in a daisy chain configuration.

14. The method of claim 10, further comprising:
a mechanism coupled to the array and configured to set a sensitivity of the array, the sensitivity being a scale based on a percentage of the full-load state.

15. A method comprising:
providing a module of a plurality of modules forming an array, each module of the plurality of modules being coupled to a neighboring module of the plurality of modules, the module comprising:
one or more flexures, each flexure configured to measure a load value; and
a module board connected to the one or more flexures;
receiving, by the module board, the load value from each flexure;
combining, by the module board, the load value from each flexure into a load module output, the load module output being within an initial module output range, the initial module output range being a difference between an output for a full-load state and an output for a zero-load state;
receiving, by a microcontroller, the load module output of each module;
converting, by the microcontroller, the load module output into a bit number;
scaling, by the microcontroller, the bit number into a scaled bit number;
generating, by the microcontroller from the scaled bit number, an adjusted bit number, the adjusted bit number representing a weight of the load applied to the array; and
transmitting, by a radio, the adjusted bit number to a backend.

16. The method of claim 15, wherein the flexure is a strain gauge, pressure gauge, piezoelectric device, or piezo-resistive device.

17. The method of claim 15, further comprising a resistor connected to the module board.

18. The method of claim 17, further comprising:
receiving, by the microcontroller from a user, an input for the initial module output range being a difference between an output for a full-load state and an output for a zero-load state;
setting, by the resistor, the initial module output range for each module in the array, the initial module output range being the same for each module in the array.

19. The method of claim 15, wherein each module is electrically connected to the neighboring module in the array in a parallel wiring circuit in a daisy chain configuration.

20. The method of claim 15, further comprising:
a mechanism coupled to the array and configured to set a sensitivity of the array, the sensitivity being a scale based on a percentage of the full-load state.
